(19) United States
(12) Patent Application Publication
(10) Pub. No.: US 2002/0066216 A1
(43) Pub. Date: Jun. 6, 2002

(54) Baby birth announcement

(76) Inventor: Cedric G. DeLaCruz, Maplewood, NJ (US)

Correspondence Address: Cedric G. DeLaCruz, 682 Prospect Street, Maplewood, NJ, 07040, US

(21) Appl. No.: 09/727,956

(22) Filed: Dec. 1, 2000

(51) Int. Cl. G09F 1/00; B42D 15/00

(52) U.S. Cl. 40/124.12; 283/117

(57) ABSTRACT

A baby's birth announcement which includes two front panels which in a folded position forms a visual composite image of the baby's parents and when unfolded reveals a picture of the baby.

### BACKGROUND OF THE INVENTION

The present invention relates to baby birth announcements or cards and more particularly, to a birth announcement having visual representations of both the parents and the baby.

It is customary, especially in the United States, that after the birth of a child the parents will send out birth announcements out to family and friends. Typically, these birth announcements are in the form of cards which include some identifying information about the new child, such as the child's name, date of birth, birth weight and other related information such as the parents' names, etc. Many times, the birth announcement will also include a picture of the new baby

However, a new, appealing and innovative configuration for birth announcements is desirable as most have become accustomed to the standard formats of these prior art birth announcements. It would also be desirable to have a birth announcement which can stylistically and inherently convey the idea of birth and the creation of life.

### SUMMARY OF THE INVENTION

The present invention is a birth announcement having at least two front panels or flaps which in a closed or folded position displays a composite image of the baby's parents and when opened or unfolded, reveals a picture of the baby or babies in an inside or back panel portion. The two front panels are pivotally coupled to the inside or back panel portion.

In one embodiment, each front panel has disposed thereon a picture of one of the baby's parents. Accordingly, the baby's other parent's picture will be disposed on the other front panel. In one embodiment, the left half of one parent's face is shown on one front panel and the right half of the other parent's face is shown on the other front panel.

In another embodiment, the top half of one parent's face is shown on one front panel and the bottom half of the other parent's face is shown on the other front panel. In yet another embodiment, at least a portion of one parent's face and at least a portion of their body is shown on one front panel and at least a portion of the other parent's face and at least a portion of their body is shown on the other front panel.

### BRIEF DESCRIPTION OF THE DRAWINGS

FIG. 1 illustrates a birth announcement of the present invention in a generally folded position.

FIG. 2 illustrates a birth announcement of the present invention in a generally unfolded position.

FIG. 3 illustrates another embodiment of a birth announcement of the present invention in a folded position.

FIG. 4 illustrates a side view of the birth announcement of FIG. 3.

FIG. 5 illustrates the birth announcement of FIGS. 3 and 4 in an unfolded position.

FIG. 6 illustrates another embodiment of a birth announcement of the present invention in a generally folded position.

FIG. 7 illustrates yet another embodiment of a birth announcement of the present invention in a generally folded position.

FIG. 8 illustrates an exemplary system for providing a birth announcement of the present invention.

FIG. 9 illustrates an exemplary method for providing a birth announcement of the present invention.

### DETAILED DESCRIPTION OF THE INVENTION

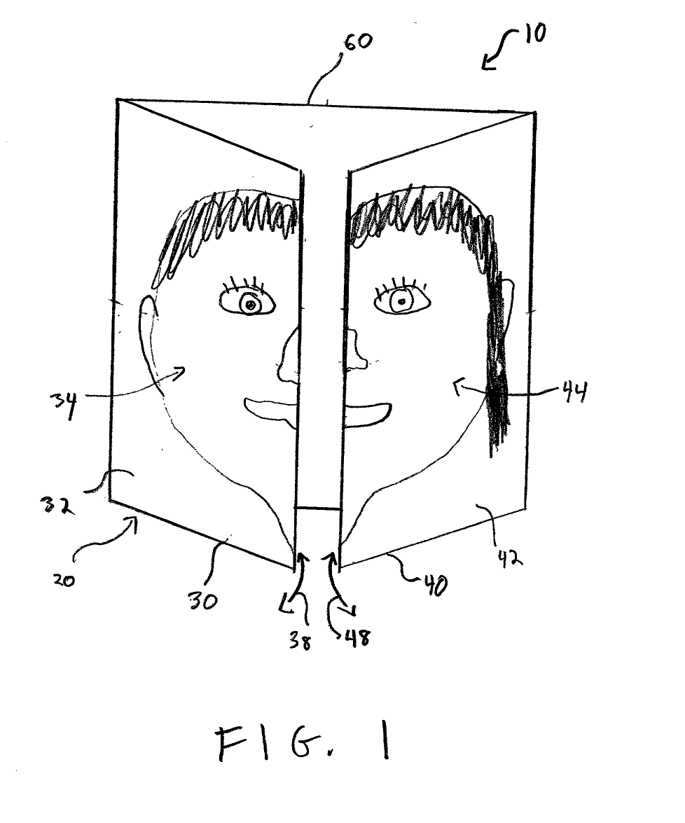

Referring to FIG. 1, a birth announcement 10 of the present invention. In a preferred embodiment, birth announcement 10 includes two front panels or flaps 30 and 40. Front panels 30 and 40 are pivotally coupled to a back or inside panel 60. In a first embodiment, front panels 30 and 40 and back panel 60 are part of a single sheet of card stock which is scored and folded to form the pivotally coupled panels. In another embodiment, front panels 30 and 40 and back panel 60 may be separate panels which a joined by a hinge mechanism, not shown, such as a spiral-type connector, hinge tape or other similar facility for joining the panels together.

Referring back to FIG. 1, front panel 30 has a front surface 32 upon which is disposed an image 34. Front panel 40 also has a front surface 42 upon which is disposed another image 44. Image 34 and image 44 together form a composite image made up of both of the baby's parents when birth announcement 10 is in a closed or folded position or configuration. For example, in one embodiment, image 34 is a visual representation of half of the face of the baby's father and image 44 is a visual representation of half of the face of the baby's mother. Conversely, in another embodiment, image 34 is a visual representation of half of the face of the baby's mother and image 44 is a visual representation of half of the face of the baby's father. In this embodiment, image 34 and image 44 may be printed upon front panel 30 and 40, respectively, in a conventional printing manner as known in the art. In other embodiments, front panels 30 and 40 may actually be photographs of the parents, which for example, have been cut in half to provide the composite image. In another embodiment, front panels 30 and 40 may be adapted to receive pictures of the parents, which may be pasted or adhered to front panels 30 and 40.

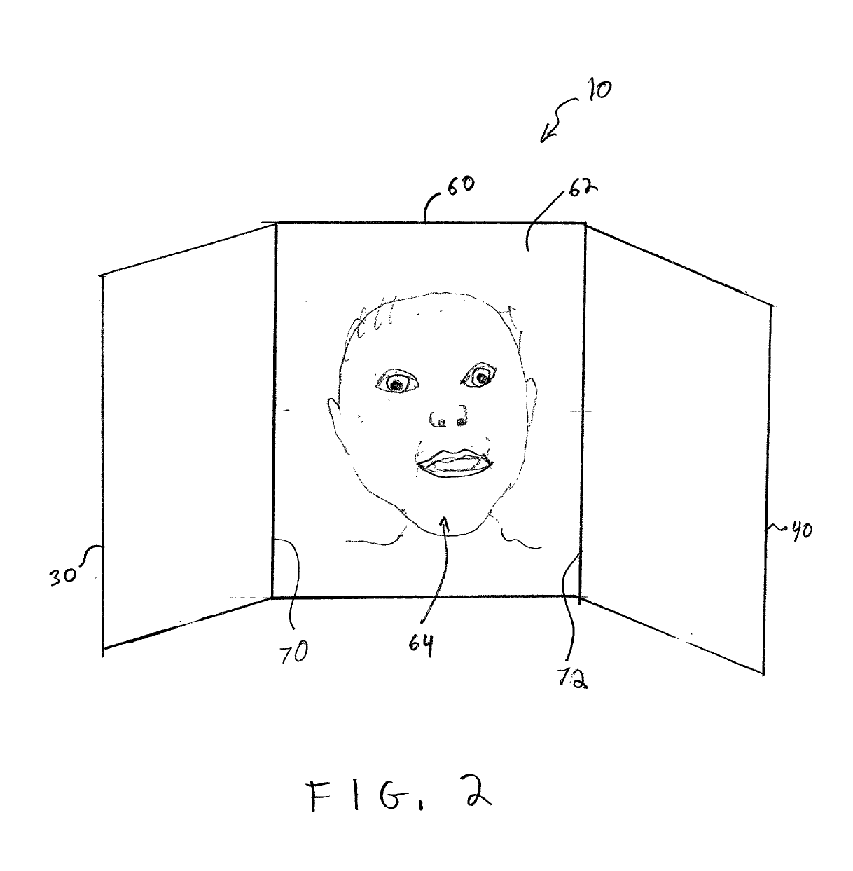

In operation, front panel 30 pivots or swings as indicated by arrow 38 and front panel 40 pivots or swings as indicated by arrow 48. In the generally folded or closed position shown in FIG. 1, front panels 30 and 40 cover back panel 60. As the front panels 30 and 40 are opened, the back panel 60 is revealed as shown now in FIG. 2.

Referring to FIG. 2, front panels 30 and 40 open up to reveal inside, center or back panel 60. Back panel 60 includes a surface 62 upon which is disposed an image 64. Image 64 is a visual representation of a baby or babies whose parents images are disposed on front panels 30 and 40 as discussed above. In the case of twins, triplets, quadruplets, quintuplets, etc., the two or more babies may be shown on back panel 60. Back or inside panel 60 may also contain other information about the baby, such as the baby's name, date of birth, birth weight and other related information such as the parents' names, etc. which may be printed or written upon back panel 60. As discussed briefly earlier herein, front panels 30 and 40 are pivotally coupled to back or inside panel 60. In this embodiment, front panels 30 and 40 are pivotally coupled to back or inside panel 60 along line 70 and 72, which in this embodiment, represent a scored lines along the inside surface of birth announcement 10. Again, as mentioned earlier, in other embodiments, front panels 30 and 40 may be attached to inside panel 60 by a hinge-type facility such as via a spiral hinge, tape hinge, or other similar mechanism.

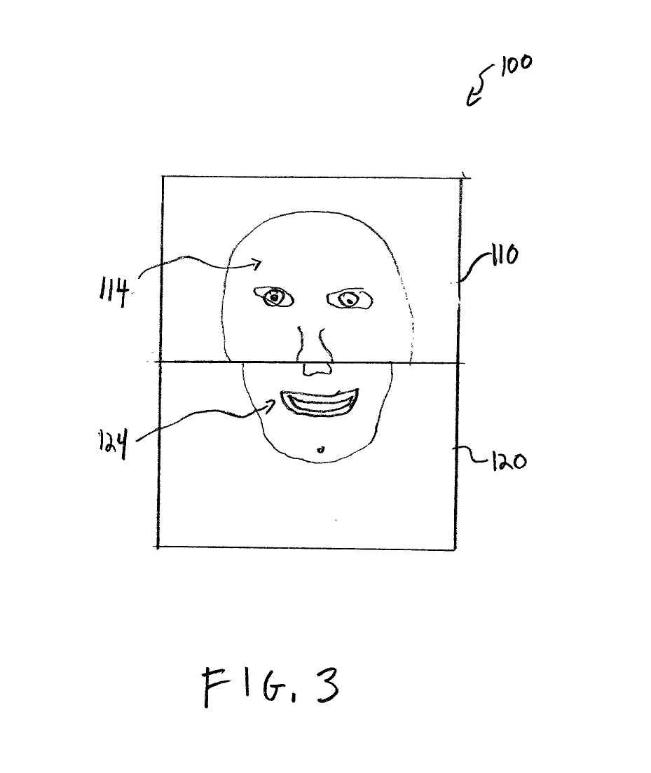

Referring to FIG. 3, another embodiment of the birth announcement is shown. As shown in FIG. 3, birth announcement 100 includes a first front panel or flap 110 and a second front panel or flap 120. First front panel 110 includes an image 114 disposed thereon of half of a parent's face. Second front panel 120 includes an image 124 disposed thereon of half of the other parent's face. The two front panels 110 and 120 together from a composite image of a single individual made up of a top half of one parent's face and the bottom half of the other parent's face.

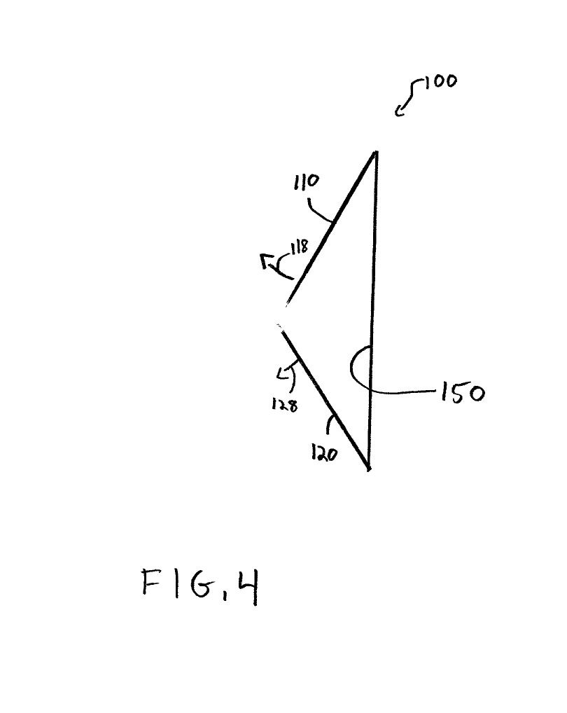

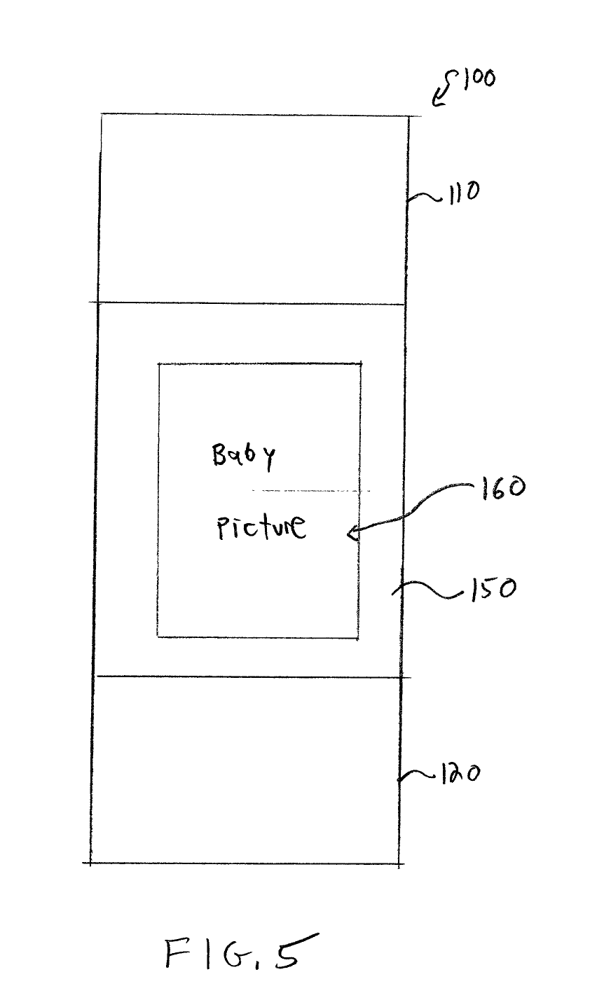

Referring to FIG. 4, birth announcement 100 is shown in a side elevational view. In a closed or folded position, front panels 110 and 120 cover a back or inside panel 150 on which is disposed a picture of the parents' baby as discussed in more detail later herein. Front panel 110 may be opened or unfolded in a direction as shown by arrow 118 and front panel 120 may be opened or unfolded in a direction 128 shown by arrow 128 to reveal inside panel 150 as now shown in FIG. 5.

Referring to FIG. 5, birth announcement 100 is shown in an open or unfolded arrangement. In this arrangement, front panels 110 and 120 are folded back to reveal inside or back panel 150. Upon inside panel 150 is disposed a visual representation or picture 160 of the baby which is revealed once front panels 110 and 120 are opened or folded back. Back or inside panel 150 may also contain other information about the baby, such as the baby's name, date of birth, birth weight and other related information such as the parents' names, etc. Such information may be imprinted upon back panel 150 is a manner as known in the art.

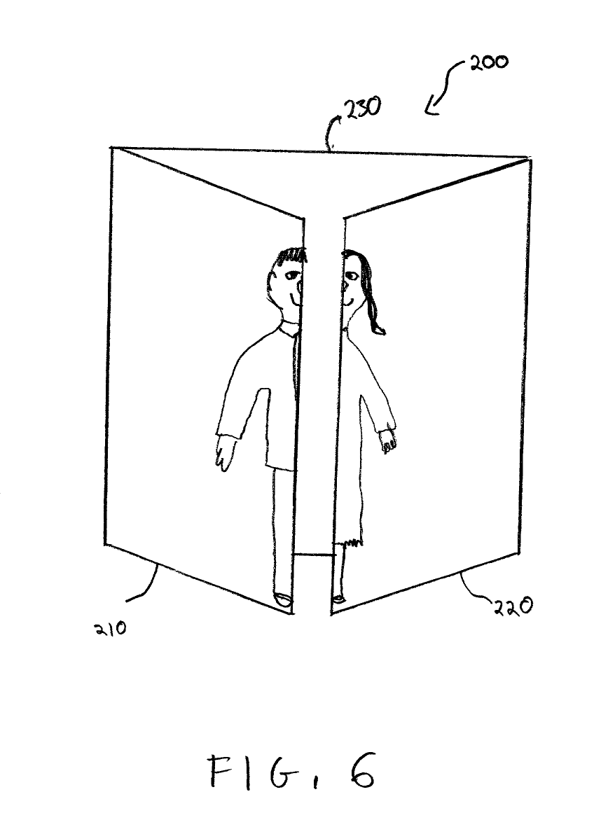

In other variations of the present invention, additional portions of the parents' images may be disposed on the birth announcement. For example, as shown in FIG. 6, instead of only half of the parents' faces being displayed on the birth announcement, half of the parent's entire bodies or at least a portion of their bodies may be shown along with their faces. In this embodiment, birth announcement 200 includes two front panels 210 and 220 which together in a folded position form a composite body image made up of two half images of both parents. In an unfolded position, a back panel 230 is revealed to show a visual representation of the parent's baby or babies.

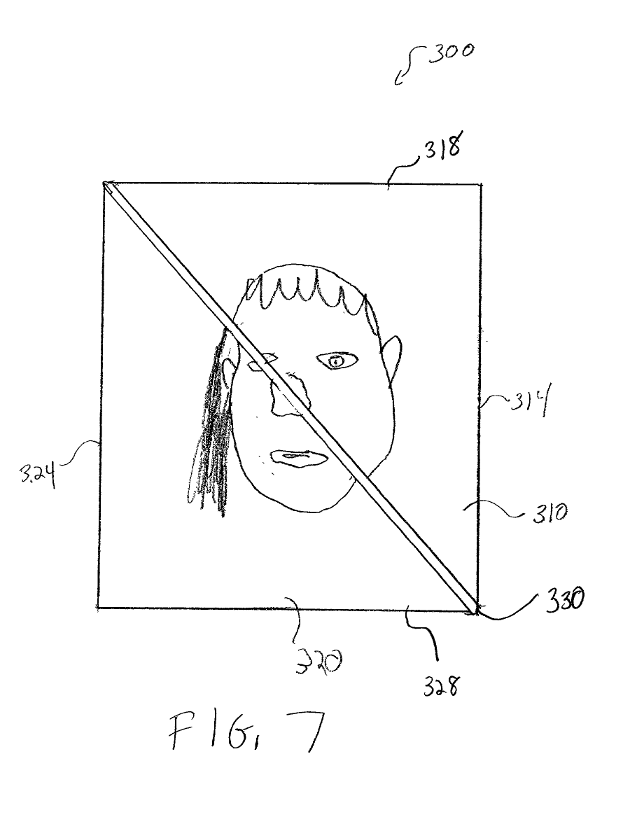

Another embodiment of the birth announcement is shown in FIG. 7. In this embodiment, birth announcement 300 includes a at least a pair of front panels 310 and 320 which are both formed in a generally triangular shape and come together to form a composite image which includes at least a portion of both parents faces and/or body parts. Front panels 310 and 320 may be pivotally coupled to a back panel 330 along edge 314 and 324. Alternatively, front panels 310 and 320 may be pivotally coupled to back panel 330 along edge 318 and 328. In this embodiment, front panels 310 and 320 are opened to reveal a picture of the parents' baby or babies, not shown.

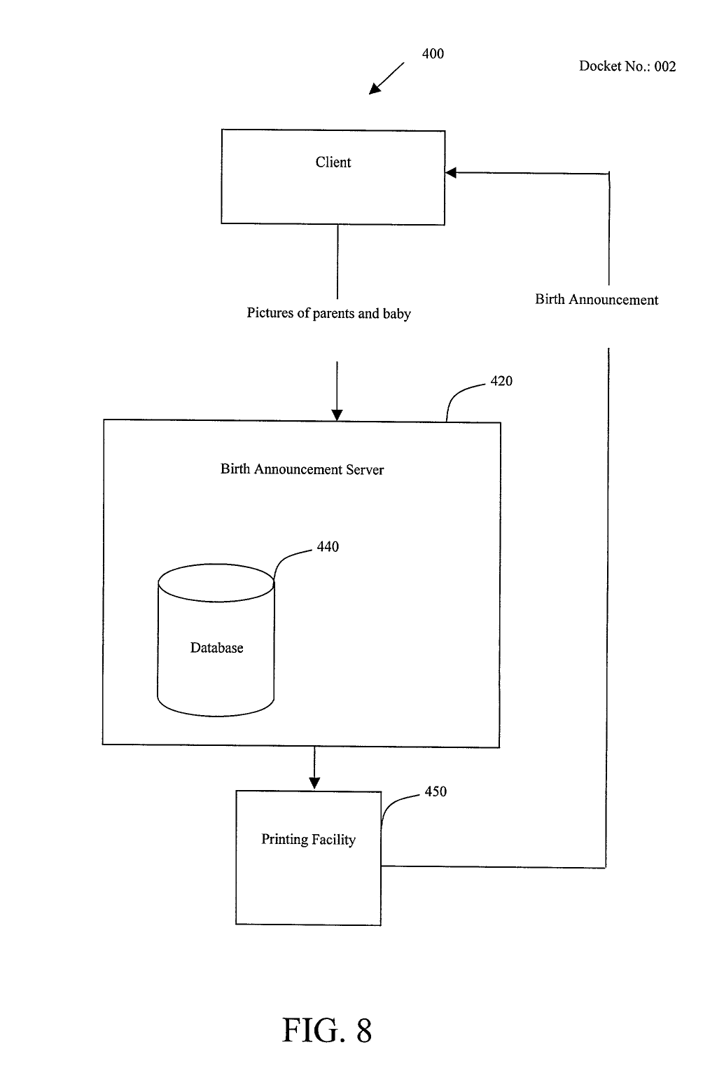

Referring to FIG. 8, an exemplary system 400 for providing a birth announcement as described above is shown. System 400 includes one or more clients 410 which communicate electronically with a birth announcement server 420. In one embodiment, client 410 may include a computer having an Internet connection while birth announcement server 420 is a Web based server responsive to communications from client 410. In this embodiment, client 410 establishes a connection with birth announcement server 420, such a by accessing a Web Page on birth announcement server 420 through a browser facility. Once a connection between client 410 and birth announcement server 420 has been established, client 410 may select certain options for the birth announcement via the Web page and provide birth announcement server 420 at least one picture of the parents and the baby, such as by uploading the picture(s) to birth announcement server 420. More than one picture may be provided, such as separate pictures, for example, of the mother, father and baby. Pictures may be provided in any number of formats such as in JPG type format, GIF type format, TIFF type format or other graphical format which may be transferred electronically. In this embodiment, birth announcement server 420 receives and processes the pictures into a birth announcement as described above and shown for example, in FIGS. 1-7. In this embodiment, certain birth announcement format options may be set via the Web page, such as the size of the birth announcement, type of paper, etc.

In another embodiment, client 410 provides birth announcement server 420 with an electronic mail message which contains an attachment, such as at least one picture of the parents and the baby. More than one attachment may be provided, such as separate pictures, for example, of the mother, father and baby. As discussed above, pictures may be provided in any number of formats such as in JPG type format, GIF type format, TIFF type format or other graphical format which may be transferred electronically. Birth announcement server 420 may include a database 440 for storing electronic mails and corresponding attachment files, such as the pictures. Birth announcement server 420 may further include or be coupled to a printer 450 which will receive the pictures provided by the client and print the pictures in a format as described above and shown for example, in FIGS. 1-7. The birth announcement(s) will then be provided to client 410, preferably in paper form, but alternatively, the birth announcement(s) may be provided in electronic form, such as via a Web page or executable application which incorporates the teachings herein as to the format of the birth announcement. For example, a file may be provided to client 410, such as via an electronic mail attachment, such that when the file is opened or run, a user will see a visual representation of the birth announcement as described above and shown for example, in FIGS. 1-7. In this embodiment, the birth announcement may be electronically activated by, for example, clicking on or placing the cursor over the visual representation of the front panels of the birth announcement, whereby the birth announcement will “open” to reveal a picture of the baby.

In another embodiment, it is conceivable clients may manually provide birth announcement server with paper based pictures instead of electronic based picture files. These pictures may then be scanned into electronic form and printed in a format as described above and shown for example, in FIGS. 1-7.

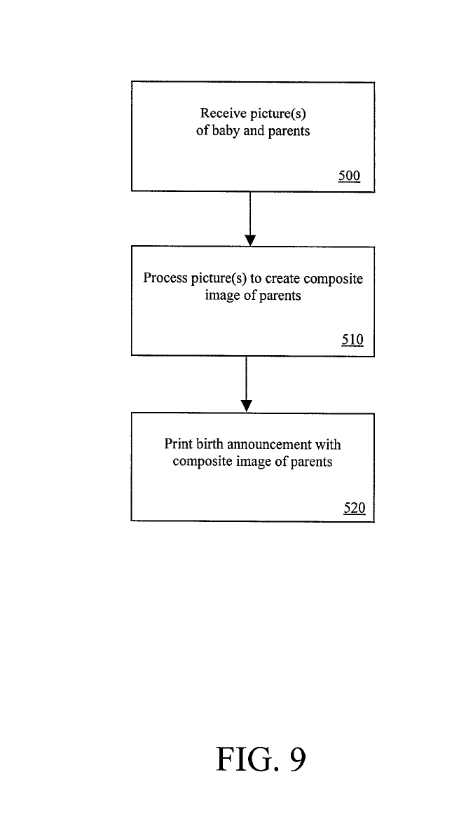

Referring to FIG. 9, there is shown an exemplary method for providing birth announcements as shown and described herein. In this embodiment, one or more pictures are received of the baby or babies and the baby or babies' parents, step 500. The pictures are processed to create a birth announcement in the format as described above and shown for example, in FIGS. 1-7 whereby the parents' pictures are formatted to create composite image, step 510. The birth announcement is printed such as in the format as described above and shown for example, in FIGS. 1-7, step 520.

It will be apparent to those skilled in the art that many changes and substitutions can be made to the system and method described herein without departing from the spirit and scope of the invention as defined by the appended claims. For example, in an embodiment involving a non-conventional parental situation, such as a same-sex couple, the front panel image would show half the faces of both same-sex parents. For example, for a lesbian couple having two female partners, the first image would be a visual representation of half of the face of the first female partner and the second image would be a visual representation of half of the face of the second female partner. In another example, a birth announcement provider may manually capture images of the parents and baby or babies, such as in a photographic studio using conventional film or alternatively, a digital camera. The captured images are then manipulated into the format in the format as described above and shown for example, in FIGS. 1-7.

We claim:

1. A birth announcement for announcing the birth of at least one baby, the at least one baby have a first parent and a second parent, the card comprising:
a front portion having a first panel and a second panel, the first panel having a picture thereon of half of the first parent, the second panel having a picture thereon of half of the second parent; and
an inside panel having a picture thereon of the at least one baby.

2. The birth announcement of claim 1, wherein the first parent is the father and the second parent is the mother.

3. The birth announcement of claim 1, wherein the first parent is the mother and the second parent is the father.

4. The birth announcement of claim 1, wherein the first panel and the second panel cover the inside panel when the card is in a closed position.

5. The birth announcement of claim 4, wherein the inside panel is revealed when the first panel and the second panel are not in the closed position.

6. The birth announcement of claim 1, wherein the pictures are photographs.

7. A greeting card for the announcement of at least one baby's birth by the at least one baby's parents, comprising:
a plurality of connected panels including:
a first front panel having a picture disposed thereon of one of the at least one baby's parents;
a second front panel having a picture disposed thereon of the other of the at least one baby's parents; and
an inside panel having a picture disposed thereon of the at least one baby.

8. The birth announcement of claim 7, wherein the plurality of connected panels are formed from a single sheet of card stock.

9. The birth announcement of claim 7, wherein the panels are connected by a hinge mechanism.

10. The birth announcement of claim 7, wherein the first front panel and the second front panel swing along a generally horizontal plane.

11. The birth announcement of claim 7, wherein the first front panel and the second front panel swing along a generally vertical plane.

12. The birth announcement of claim 7, wherein the first front panel and the second front panel are shaped in a generally rectangular configuration.

13. The birth announcement of claim 7, wherein the first front panel and the second front panel are shaped in a generally triangular configuration.

14. The birth announcement of claim 7, wherein the pictures are printed upon the front panels.

15. A birth announcement for announcing the birth of at least one baby, comprising:
a back panel having an image of the at least one baby thereon; and
two front panels having being pivotally coupled to the back panel, each of the two front panels covering the image of the baby in a folded position, the front panels in the folded position forming a composite image of the baby's parents.

16. The birth announcement of claim 15, wherein the front panels reveal the image of the baby in an unfolded position.

17. The birth announcement of claim 15, wherein the composite image is comprised of half of each of the parent's images.

18. The birth announcement of claim 15, wherein the back panel and the two front panels are formed from a single sheet.

19. The birth announcement of claim 15, wherein the two front panels are semi-transparent.

20. The birth announcement of claim 15, wherein the image of the baby is the same size as the composite image of the parents.
